(19) United States
(12) Patent Application Publication
(10) Pub. No.: US 2022/0147347 A1
(43) Pub. Date: May 12, 2022

(54) SEQUENCE DIAGRAM GENERATION APPARATUS

(71) Applicant: Mitsubishi Electric Corporation, Chiyoda-ku, Tokyo (JP)

(72) Inventor: Ichio MOTEGI, Chiyoda-ku, Tokyo (JP)

(73) Assignee: Mitsubishi Electric Corporation, Chiyoda-ku, Tokyo (JP)

(21) Appl. No.: 17/429,961

(22) PCT Filed: Feb. 26, 2019
(86) PCT No.: PCT/JP2019/007298

§ 371 Date: Aug. 11, 2021

(51) Int. Cl. G06F 8/73

(52) U.S. Cl. CPC G06F 8/73

(57) ABSTRACT

A source code analyzer extracts software components from a source code, and extracts a call relationship indicating a relationship on calls and returns among the software components. A tree diagram generator generates a tree diagram of the source code based on the extracted software components and call relationship. A sequence diagram generator generates a sequence diagram of the source code based on the extracted software components and call relationship. The tree diagram generator generates a tree diagram including specified software components, and excluding other specified software components. The sequence diagram generator generates a sequence diagram including the software component included in the tree diagram generated by the tree diagram generator, and excluding the software component excluded from the tree diagram generated by the tree diagram generator.

### TECHNICAL FIELD

The present invention relates to a sequence diagram generation apparatus for generating a sequence diagram from a source code including a plurality of software components.

### BACKGROUND ART

A source code of a computer program is constituted of various software components, such as functions, processes, modules, packages, classes, and function blocks (function groups). It is known to create a sequence diagram (also referred to as a “call sequence diagram”) based on relationship on calls and returns among software components included in a source code, in order to analyze the source code.

When creating a sequence diagram, a user specifies, for example, a starting point, scope, and granularity of the sequence diagram. The starting point of the sequence diagram indicates a position in the source code, where processing associated with the sequence diagram starts or ends. The scope of the sequence diagram indicates, for example, a depth of calls and returns among software components included in the sequence diagram. The granularity of a sequence diagram indicates which level of software components, for example, functions, processes, modules, packages, classes, and function blocks (function groups), is used as the basis to create the sequence diagram.

The starting point or the scope of the sequence diagram may be changed to facilitate understanding of the sequence diagram. By limiting the scope of the sequence diagram, unnecessary data is deleted and it facilitate understanding of the overview of the processing. In addition, the granularity of the sequence diagram may be changed to facilitate understanding of the sequence diagram. By combining a plurality of functions into one function block, the sequence diagram is simplified and it facilitate understanding of the overview of the processing.

For example, Patent Documents 1 and 2 disclose exemplary sequence diagram generation apparatuses.

### CITATION LIST

### Patent Documents

PATENT DOCUMENT 1: Japanese Patent Laid-open Publication No. JP 2004-094496 A

PATENT DOCUMENT 2: Japanese Patent Laid-open Publication No. JP 2007-041638 A

### SUMMARY OF INVENTION

### Technical Problem

When analyzing a large-scale source code, the source code includes a large number of software components, and the source code may include a plurality of software components as starting points. In addition, in this case, the software components as starting points may be at very deep positions in the hierarchical structure of the source code. In such a case, there is a problem that it takes time and effort to specify a starting points, scope, and granularity of a sequence diagram, and it also takes time and effort to change them.

An object of the present invention is to solve such a problem, and provide a sequence diagram generation apparatus capable of generating a sequence diagram by more easily specifying a starting point, scope, and granularity of the sequence diagram with less time and effort than the prior art.

### Solution to Problem

A sequence diagram generation apparatus according to an aspect of the present invention generates a sequence diagram from a source code including a plurality of software components. The apparatus is provided with: a source code analyzer configured to extract the software components from the source code, and extract a call relationship indicating a relationship on calls and returns among the software components; a tree diagram generator configured to generate a tree diagram of the source code based on the software components and the call relationship extracted by the source code analyzer; and a sequence diagram generator configured to generate a sequence diagram of the source code based on the software components and the call relationship extracted by the source code analyzer, The tree diagram generator generates a tree diagram including specified software components, and excluding other specified software components. The sequence diagram generator generates a sequence diagram including the software component included in the tree diagram generated by the tree diagram generator, and excluding the software component excluded from the tree diagram generated by the tree diagram generator.

### Advantageous Effects of Invention

An aspect of the present invention can generate the sequence diagram by more easily specifying the starting point, scope, and granularity of the sequence diagram with less time and effort than the prior art.

### BRIEF DESCRIPTION OF DRAWINGS

FIG. 1 is a block diagram illustrating components of a sequence diagram generation apparatus 100 according to an embodiment.

FIG. 2 is a flowchart illustrating the operation of the sequence diagram generation apparatus 100 according to the embodiment.

FIG. 3 is a table indicating a first example of generation parameters used by the sequence diagram generation apparatus 100 according to the embodiment.

FIG. 4 is a first exemplary tree diagram corresponding to the generation parameters of FIG. 3.

FIG. 5 is a first exemplary sequence diagram corresponding to the generation parameters of FIG. 3.

FIG. 6 is a table indicating a second example of generation parameters used by the sequence diagram generation apparatus 100 according to the embodiment.

FIG. 7 is a second exemplary tree diagram corresponding to the generation parameters of FIG. 6.

FIG. 8 is a second exemplary sequence diagram corresponding to the generation parameters of FIG. 6.

FIG. 9 is a table indicating a third example of generation parameters used by the sequence diagram generation apparatus 100 according to the embodiment.

FIG. 10 is a third exemplary tree diagram corresponding to the generation parameters of FIG. 9.

FIG. 11 is a third exemplary sequence diagram corresponding to the generation parameters of FIG. 9.

FIG. 12 is a table indicating a fourth example of generation parameters used by the sequence diagram generation apparatus 100 according to the embodiment.

FIG. 13 is a fourth exemplary tree diagram corresponding to the generation parameters of FIG. 12.

FIG. 14 is a fourth exemplary sequence diagram corresponding to the generation parameters of FIG. 12.

FIG. 15 is a fifth exemplary tree diagram displayed by the sequence diagram generation apparatus 100 according to the embodiment.

FIG. 16 is a sixth exemplary tree diagram displayed by the sequence diagram generation apparatus 100 according to the embodiment.

FIG. 17 is a seventh exemplary tree diagram displayed by the sequence diagram generation apparatus 100 according to the embodiment.

FIG. 18 is an eighth exemplary tree diagram displayed by the sequence diagram generation apparatus 100 according to the embodiment.

### DESCRIPTION OF EMBODIMENTS

### Embodiment

Hereinafter, an embodiment of the present invention will be described with reference to the drawings. In the drawings, the same reference signs indicate similar components.

[Overall Configuration]

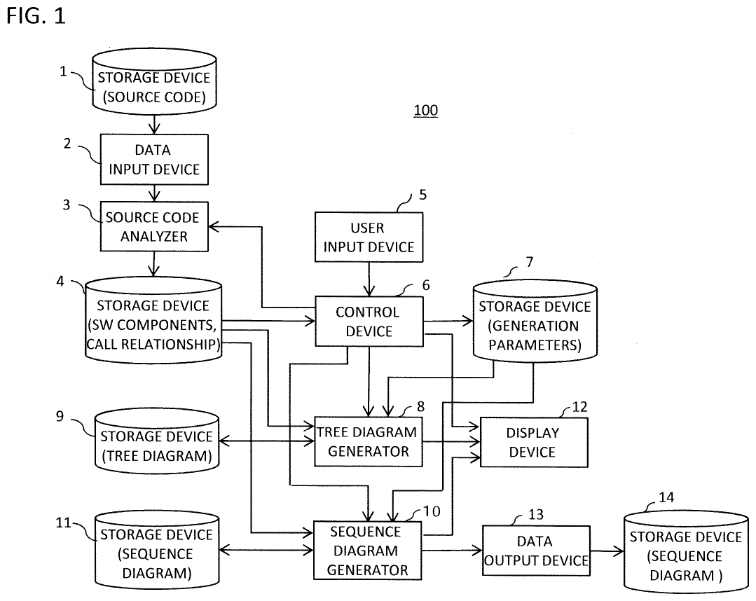

FIG. 1 is a block diagram illustrating a configuration of a sequence diagram generation apparatus 100 according to an embodiment. An overview of the configuration of the sequence diagram generation apparatus 100 will be described with reference to FIG. 1.

The sequence diagram generation apparatus 100 is provided with storage devices 1, 4, 7, 9, 11, and 14, a data input device 2, a source code analyzer 3, a user input device 5, a control device 6, a tree diagram generator 8, a sequence diagram generator 10, a display device 12, and a data output device 13. The sequence diagram generation apparatus 100 generates a sequence diagram from a source code including a plurality of software components.

The storage device 1 stores at least one source code in advance. Each source code includes a plurality of software components. Software components include, for example, processes, modules, packages, classes, and function blocks (function groups). Hereinafter, in the examples of the present specification, the software components include a plurality of functions, and a plurality of function blocks each including at least one function. In other words, the software components have two levels of granularity, including functions and function blocks. The source code stored in the storage device 1 is read by the source code analyzer 3 via the data input device 2.

The source code analyzer 3 analyzes the source code to extract a plurality of software (SW) components from the source code, and extract a call relationship indicating a relationship on calls and returns among the software components. The source code analyzer 3 stores the extracted software components and the extracted call relationship, in the storage device 4.

The user input device 5 acquires user inputs for specifying a starting point, scope, and granularity of a sequence diagram. In the examples of the present specification, in order to specify a starting point, scope, and granularity of a sequence diagram, the user input device 5 acquires user inputs (also referred to as “tree diagram generation parameters”) specifying the starting point, scope, and granularity of the tree diagram to be generated by the tree diagram generator 8 described below. The tree diagram generation parameters individually specify software components to be included in the tree diagram, and software components to be excluded from the tree diagram. The user input device 5 includes a keyboard, a pointing device, and the like.

The control device 6 controls operations of the components of the sequence diagram generation apparatus 100.

The storage device 7 stores the tree diagram generation parameters acquired by the user input device 5, under the control of the control device 6.

The tree diagram generator 8 generates a tree diagram (also referred to as “call tree diagram”) of the source code based on the software components and the call relationship extracted by the source code analyzer 3. In this case, the tree diagram illustrates the call relationship among the software components of the source code, as a tree, as will be described below with reference to FIG. 4 and others. The tree diagram generator 8 generates a tree diagram including the software components specified by the user inputs, and excluding other software components specified by the user inputs. The tree diagram generator 8 stores the generated tree diagram in the storage device 9, and displays the generated tree diagram on the display device 12.

The sequence diagram generator 10 generates a sequence diagram of the source code based on the software components and the call relationship extracted by the source code analyzer 3. The sequence diagram generator 10 generates the sequence diagram including the software components included in the tree diagram generated by the tree diagram generator 8, and excluding the software components excluded from the tree diagram generated by the tree diagram generator 8. The sequence diagram generator 10 stores the generated sequence diagram in the storage device 11, and displays the generated sequence diagram on the display device 12. In addition, the sequence diagram generator 10 outputs the sequence diagram finally approved by a user, via the data output device 13, and stores the sequence diagram in the storage device 14.

Although the storage devices 1, 4, 7, 9, 11, and 14 are illustrated as separate components in FIG. 1, they may be provided as a single component. In addition, the sequence diagram generation apparatus 100 including with the components of FIG. 1 may be provided as an integrated apparatus, such as a personal computer, or may be provided as a combination of a plurality of apparatuses. For example, at least one of the data input device 2 and the data output device 13 may be an interface, such as a universal serial bus (USB) interface, and in this case, the storage device 1 or 14 is a removable storage medium. In addition, at least one of the data input device 2 and the data output device 13 may be a network interface, and in this case, the storage device 1 or 14 is a remote storage medium connected via a network.

[Overview of Operation]

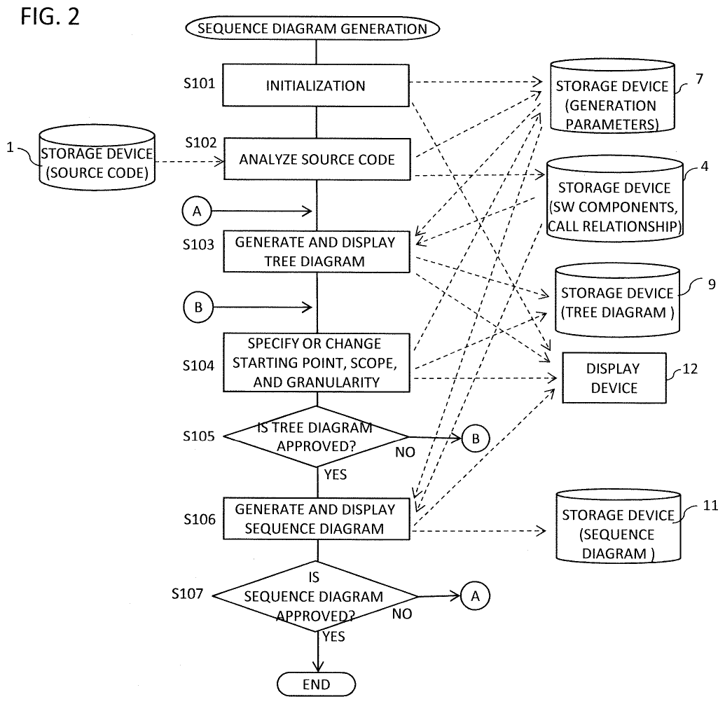

FIG. 2 is a flowchart illustrating the operation of the sequence diagram generation apparatus 100 according to the embodiment. With reference to FIG. 2, an overview of the operation of the sequence diagram generation apparatus 100 generating a sequence diagram from a source code will be described.

When the sequence diagram generation apparatus 100 is activated, in step S101, the control device 6 performs initialization of the sequence diagram generation. The control device 6 displays a menu and/or a guidance for generating a sequence diagram, on the display device 12. A user specifies one of the source codes stored in the storage device 1 in advance, using the user input device 5, according to the menu and/or the guidance. In addition, the control device 6 sets the initial values of the tree diagram generation parameters, and stores the set initial values in the storage device 7. For example, the control device 6 may set the initial values of the tree diagram generation parameters so as to generate a tree diagram of the entire source code, including all the functions of the source code, but not including function blocks.

In step S102, the control device 6 causes the source code analyzer 3 to analyze the source code. The source code analyzer 3 reads the source code specified by the user in step S101, from the storage device 1, and extracts the software components and the call relationship from the read source code. In the example of the present specification, the source code analyzer 3 extracts a plurality of functions as software components, from the source code, and extracts the call relationship among the functions. The source code analyzer 3 stores the extracted software components and the extracted call relationship, in the storage device 4. In addition, for use in setting the tree diagram generation parameters, the control device 6 reads the software components from the storage device 4, and stores the read software components in the storage device 7.

When the source code analyzer 3 has completed the analysis of the source code, in step S103, the control device 6 causes the tree diagram generator 8 to generate a tree diagram of the source code. The tree diagram generator 8 reads the tree diagram generation parameters stored in the storage device 7, and reads the software components and the call relationship stored in the storage device 4. The tree diagram generator 8 generates a tree diagram from the software components and the call relationship based on the tree diagram generation parameters. The tree diagram generator 8 generates, for example, a tree diagram of the entire source code, including all the functions of the source code, but not including function blocks, based on the initial values of the tree diagram generation parameter. The tree diagram generator 8 stores the generated tree diagram in the storage device 9, and displays the generated tree diagram on the display device 12.

When the tree diagram generator 8 has generated the tree diagram and displayed the tree diagram on the display device 12, in step S104, the control device 6 specifies or changes the tree diagram generation parameters (that is, the starting point, scope, and granularity of the tree diagram) in response to user inputs. The control device 6 displays a menu and/or a guidance for specifying or changing the tree diagram generation parameters, on the display device 12. The user individually specifies software components to be included in the tree diagram, and software components to be excluded from the tree diagram, through the user input device 5. For example, the user groups the functions into function block each including some functions, using the user input device 5. In addition, the control device 6 may automatically group a plurality of functions each having function names or arguments including a common character string, as functions belonging to the same function block. In addition, using the user input device 5, the user individually specifies functions to be included in the tree diagram, and functions to be excluded from the tree diagram, and individually specifies function blocks to be included in the tree diagram, and function blocks excluded from the tree diagram. As a result, the starting point, scope, and granularity of the tree diagram are specified or changed. The control device 6 stores the specified or changed tree diagram generation parameters in the storage device 7. The control device 6 then causes the tree diagram generator 8 to generate an updated tree diagram in a manner similar to that of step S103, based on the specified or changed tree diagram generation parameters. The tree diagram generator 8 stores the updated tree diagram in the storage device 9, and displays the updated tree diagram on the display device 12.

In step S105, the user checks the tree diagram displayed on the display device 12, and determines whether or not to approve the generated tree diagram (that is, whether to require no further change of the starting point, scope, and granularity of the tree diagram). The control device 6 acquires a user input indicating whether or not the user approves the generated tree diagram, through the user input device 5. If step S105 is YES, the flow proceeds to step S106; and if step S105 is NO, the flow returns to step S104.

In step S106, the control device 6 causes the sequence diagram generator 10 to generate a sequence diagram of the source code. The sequence diagram generator 10 reads the tree diagram generation parameters stored in the storage device 7, and reads the software components and the call relationship stored in the storage device 4. The sequence diagram generator 10 generates a sequence diagram from the software components and the call relationship based on the tree diagram generation parameters. The sequence diagram generator 10 stores the generated tree diagram in the storage device 11, and displays the generated tree diagram on the display device 12.

In step S107, the user checks the sequence diagram displayed on the display device 12, and determines whether or not to approve the generated sequence diagram (that is, whether to require no further change of the starting point, scope, and granularity of the sequence diagram). The control device 6 acquires a user input indicating whether or not the user approves the generated sequence diagram, through the user input device 5. If step S107 is YES, the control device 6 causes the sequence diagram generator 10 to output the sequence diagram to the storage device 14 via the data output device 13, and the flow ends. On the other hand, if step S105 is NO, the flow returns to step S103. Next, in step S104, the tree diagram generation parameters are changed, and then in step S106, an updated sequence diagram is generated based on the changed generation parameters. In step S107 again, the user checks the sequence diagram displayed on the display device 12, and determines whether or not to approve the generated sequence diagram.

[Exemplary Operation]

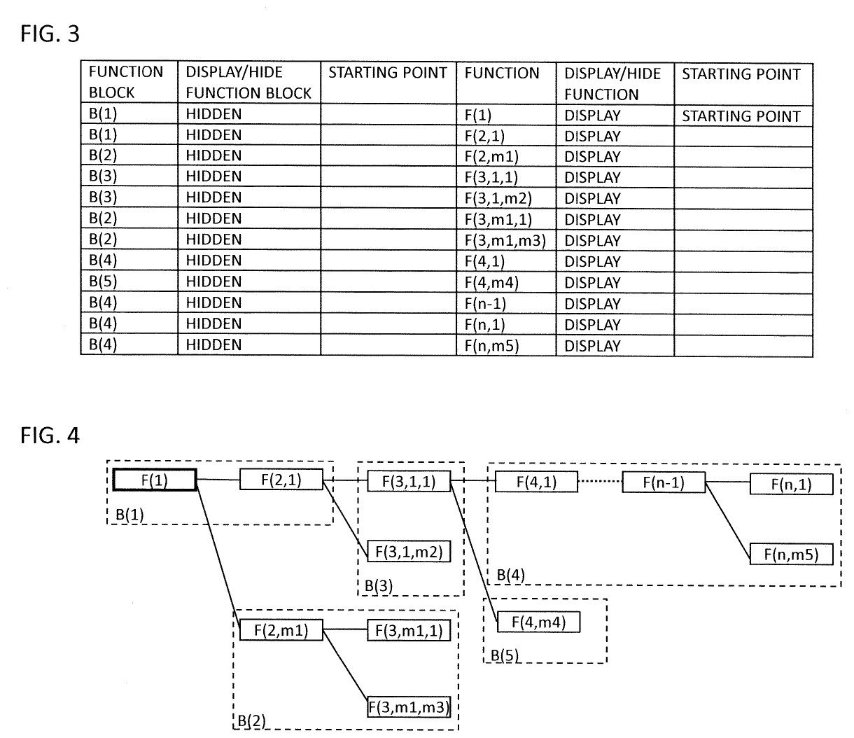

Next, an exemplary operation of the sequence diagram generation apparatus 100 will be described with reference to FIGS. 3 to 8.

FIG. 3 is a table indicating a first example of generation parameters used by the sequence diagram generation apparatus 100 according to the embodiment. The generation parameters in FIG. 3 include identification information of functions extracted by the source code analyzer 3, such as function names F(1), and F(2,1), and the like. The function name may be extracted from the source code, or acquired from a user through the user input device 5. In addition, the generation parameters of FIG. 3 include identification information of function blocks each including a group of some functions, such as function block names B(1), and B(2), and the like. The function block name may be set to the function name of any of the functions included in the function block (for example, the function name of the function to be called first), or may be acquired from the user through the user input device 5. In addition, the generation parameters in FIG. 3 include flags individually specifying functions to be included in the tree diagram (displayed functions), and functions to be excluded from the tree diagram (hidden functions). In addition, the generation parameters of FIG. 3 include flags individually specifying function blocks to be included in the tree diagram (displayed function blocks), and function blocks to be excluded from the tree diagram (hidden function blocks). In addition, the generation parameters of FIG. 3 include flags each specifying whether or not to highlight the corresponding function and/or function block as a starting point of the tree diagram and the sequence diagram.

In the example of FIG. 3, the generation parameters are set so as to generate a tree diagram of the entire source code including all the functions of the source code, but not including function blocks. In addition, in the example of FIG. 3, the plurality of functions is arranged in the ascending order of the depth of calls from function F(1), with function F(1) as the starting point where the processing starts, and functions at the same depth are arranged in the order in which they are called. In addition, in the example of FIG. 3, function F(1) is specified to be highlighted as the starting point of the tree diagram and the sequence diagram.

FIG. 4 is a first exemplary tree diagram corresponding to the generation parameters of FIG. 3. In the example of FIG. 4, the tree diagram includes all the functions in the source code, while “hidden” function blocks are also indicated by dashed lines. In addition, in the example of FIG. 4, the function F(1) is highlighted as the starting point of the tree diagram.

In the present embodiment, the purpose of using the tree diagram and its generation parameters is to finally generate a sequence diagram. Therefore, as used herein, when a software component is “included” in a tree diagram, it essentially means that the software component is included in the sequence diagram. Similarly, when a software component is “excluded” from a tree diagram, it essentially means that the software component is excluded from the sequence diagram. For this reason, software components excluded from the tree diagram (that is, “hidden” software components) may be displayed by dashed lines or a changed color (gray, translucent, or the like) as illustrated in FIG. 4, or alternatively, may be completely invisible.

When the tree diagram is displayed on the display device 12, the user may individually specify software components to be included in the tree diagram, and software components to be excluded from the tree diagram, through the user input device 5. In addition, the control device 6 may display the contents of the generation parameters of FIG. 3 on the display device 12. When the contents of the generation parameters of FIG. 3 are displayed on the display device 12, the user may individually specify software components to be included in the tree diagram, and software components to be excluded from the tree diagram, through the user input device 5. The control device 6 and the tree diagram generator 8 may simultaneously display the generation parameters of FIG. 3 and the tree diagram of FIG. 4 on the display device 12, or may alternately display them on the display device 12.

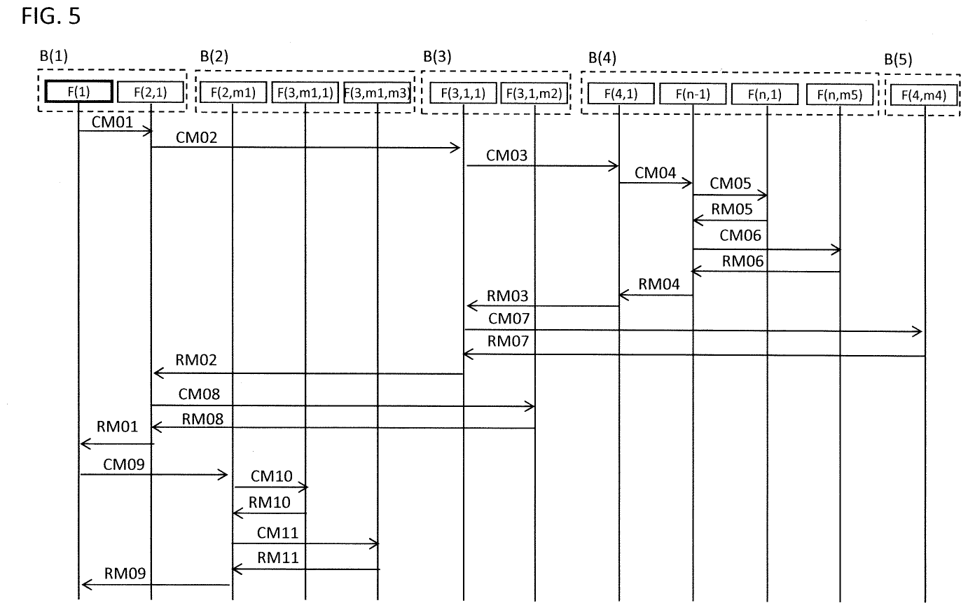

FIG. 5 is a first exemplary sequence diagram corresponding to the generation parameters of FIG. 3. Call messages CM01 to CM11 and return messages RM01 to RM11 are issued among the functions. For example, the call message CM01 indicates a call from function F(1) to function F(2,1), and the return message RM01 indicates a return from function F(2,1) to function F(1), corresponding to the call message CM01. In a case where the sequence diagram includes all the functions in the source code, the sequence diagram generator 10 generates a sequence diagram including all the call messages CM01 to CM11 and all the return messages RM01 to RM11. In addition, in the example of FIG. 5, function F(1) is highlighted as the starting point of the sequence diagram.

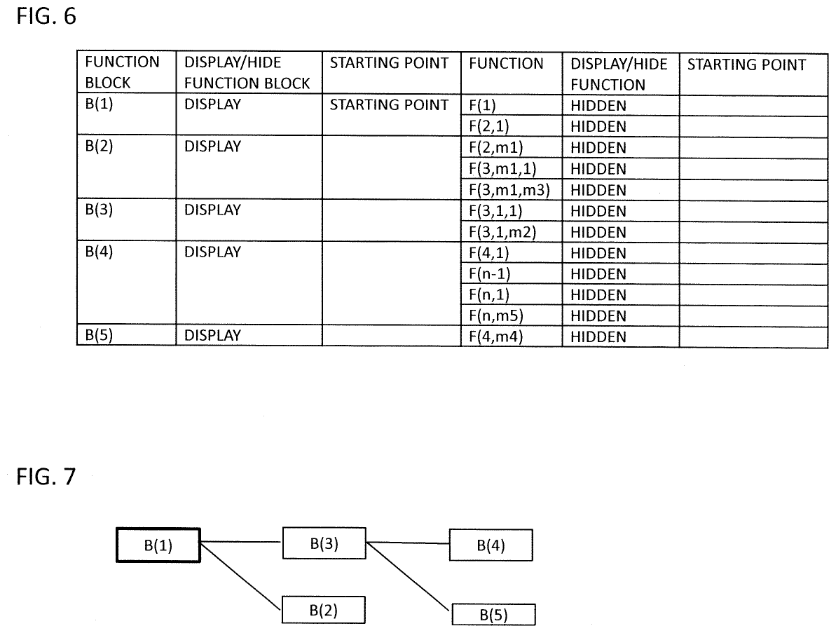

FIG. 6 is a table indicating a second example of generation parameters used by the sequence diagram generation apparatus 100 according to the embodiment. FIG. 6 illustrates the generation parameters specifying a granularity different from that of FIG. 3 for the same source code as that of FIG. 3. For example, function block B(1) including a group of functions F(1) and F(2,1) is specified. In the example of FIG. 6, the generation parameters are set so as to generate a tree diagram of the entire source code including all the function blocks, but not including functions. In addition, in the example of FIG. 6, the plurality of function blocks is arranged in the ascending order of the depth of calls from function block B(1), with function block B(1) as the starting point where the processing starts, and function blocks at the same depth are arranged in the order in which they are called. In addition, in the example of FIG. 6, function block B(1) is specified to highlighted as the starting point of the tree diagram and the sequence diagram.

FIG. 7 is a second exemplary tree diagram corresponding to the generation parameters of FIG. 6. In the example of FIG. 7, the tree diagram includes all the function blocks, but does not include functions. In addition, in the example of FIG. 7, function block B(1) is highlighted as the starting point of the tree diagram.

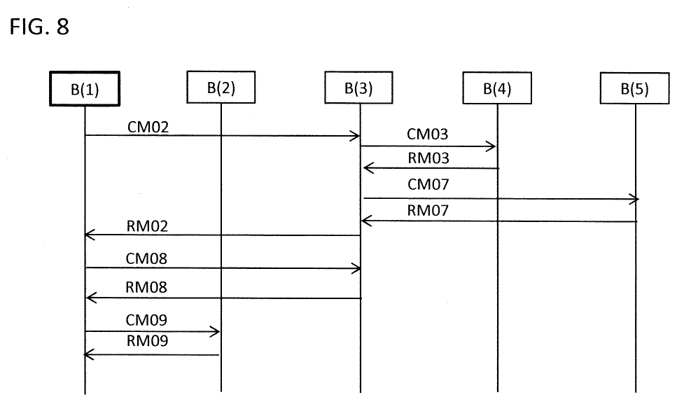

FIG. 8 is a second exemplary sequence diagram corresponding to the generation parameters of FIG. 6. Call messages CM02 to CM09 and return messages RM02 to RM09 are issued among the function blocks. For example, the call message CM02 indicates a function call from function F(2,1) included in function block B(1), to function F(3,1,1) included in function block B(3), and the return message RM02 indicates a return from function F(3,1,1) to function F(2,1), corresponding to the call message CM02. In a case where the sequence diagram includes the function blocks, but does not include functions, the sequence diagram generator 10 generates a sequence diagram not including call messages and return messages (CM01, RM01, etc.) issued among functions included in the same function block, but including call messages and return messages (CM02, RM02, etc.) issued among functions included in different function blocks. In addition, in the example of FIG. 8, function block B(1) is highlighted as the starting point of the sequence diagram.

In a case where a displayed function block includes only one hidden function, the tree diagram and the sequence diagram may include the function, instead of the function block.

Comparing FIGS. 6 to 8 with FIGS. 3 to 5, since the granularity of the software components is changed from the function to the function block, the number of software components decreases in both the tree diagram and the sequence diagram, and thus, the number of call and return messages also decreases. Thus, both the tree diagram and the sequence diagram are simplified, and it facilitates understanding them.

The sequence diagram generation apparatus 100 according to the embodiment operates as follows.

When the sequence diagram generation apparatus 100 is activated, in step S101 the storage device 7 does not store anything as the tree diagram generation parameter in the initial state.

In step S102, the source code analyzer 3 extracts the functions and the call relationship from the source code, and stores them in the storage device 4.

In step S103, the tree diagram generator 8 generates the tree diagram from the functions and the call relationship based on the tree diagram generation parameters. In this case, since the storage device 7 does not store anything as the tree diagram generation parameter in the initial state as described above, the tree diagram generator 8 generates a tree diagram of the entire source code, for example, including all the functions of the source code, but not including function blocks, as illustrated in FIG. 4.

In step S104, when the tree diagram generation parameters (that is, the starting point, scope, and granularity of the tree diagram) are not changed, the control device 6 stores, in the storage device 7, the function names of the functions extracted from the source code, as tree diagram generation parameters. In addition, the control device 6 stores, in the storage device 7, flags individually specifying that each of the functions is to be included in the tree diagram, as tree diagram generation parameters.

In step S105, if the user determines not to approve the generated tree diagram, step S104 is repeated to change the tree diagram generation parameters. In this case, for example, as illustrated in FIG. 6, the control device 6 stores, in the storage device 7, flags individually specifying that functions are to be excluded from the tree diagram, and function blocks are to be included in the tree diagram, as tree diagram generation parameters. The tree diagram generator 8 generates a tree diagram of the entire source code, for example, including function blocks, but not including functions, as illustrated in FIG. 7.

In step S105, if the user determines to approve the generated tree diagram, in step S106, the sequence diagram generator 10 generates, for example, the sequence diagram of FIG. 5 based on the tree diagram generation parameters of FIG. 4, or the sequence diagram of FIG. 8 based on the tree diagram generation parameters of FIG. 7.

In step S107, if the user determines not to approve the generated sequence diagram, steps S103 to S06 are repeated, and in step S104, the tree diagram generation parameters are changed. On the other hand, in step S107, if the user determines to approve the generated sequence diagram, the flow ends.

The sequence diagram generation apparatus 100 according to the embodiment has the following special advantageous effects.

The sequence diagram generation apparatus 100 according to the embodiment can easily change a starting point, scope, and granularity of a tree diagram to generate the tree diagram, and therefore, can easily change a starting point, scope, and granularity of a sequence diagram corresponding to the tree diagram to generate the sequence diagram. The user selects software components included in the tree diagram, while checking the structure of the source code. Accordingly, the sequence diagram generation apparatus 100 can easily change the starting point and the scope of the sequence diagram, and can easily change the granularity of the sequence diagram from a coarse granularity for viewing the entire source code, to a fine granularity including, for example, only a single function block. Thus, according to the sequence diagram generation apparatus 100 of the embodiment, it is possible to generate and display a desired sequence diagram, while checking the structure of the source code at an appropriate granularity. Therefore, it is possible to make the source code analysis efficient, and improve the quality of the source code.

By displaying a tree diagram including only the selected software components (function blocks or functions), it is possible to change the scope of the sequence diagram to be outputted from the entire source code, while checking the scope.

### Modified Embodiment

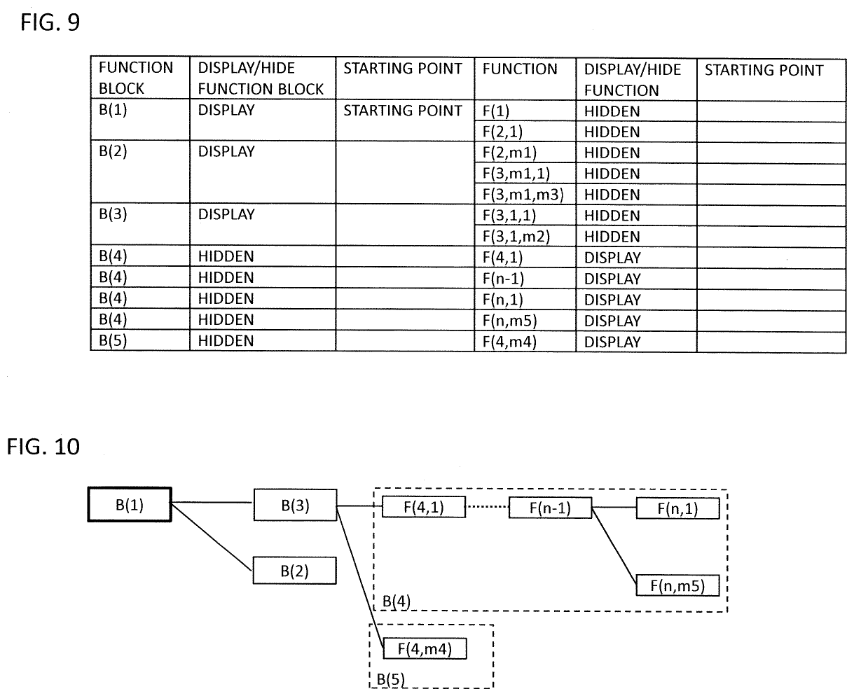

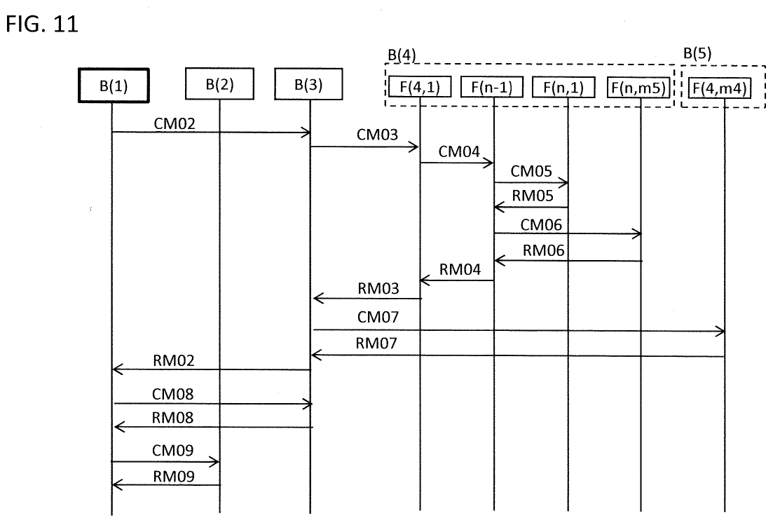

FIG. 9 is a table indicating a third example of generation parameters used by the sequence diagram generation apparatus 100 according to the embodiment. FIG. 10 is a third exemplary tree diagram corresponding to the generation parameters of FIG. 9. FIG. 11 is a third exemplary sequence diagram corresponding to the generation parameters of FIG. 9. FIG. 3 illustrates the exemplary case where the generation parameters include functions, but do not include function blocks, and FIG. 6 illustrates the exemplary case where the generation parameters include function blocks, but do not include functions. Alternatively, as illustrated in FIG. 9, the generation parameters may include both functions and function blocks. In the example of FIG. 9, the generation parameters are set so as to generate a tree diagram including function blocks B(1), B(2), and B(3), not including function blocks B(4) or B(5), not including functions of function blocks B(1), B(2), and B(3), such as function F(1), F(2,1), etc., and including functions of function blocks B(4) and B(5), such as function F(4,1), etc. In addition, as illustrated in FIG. 10, it is possible to generate a tree diagram that is partially simplified at function block B(1), B(2), and B(3), and partially detailed at function block B(4). In addition, as illustrated in FIG. 11, it is possible to generate a sequence diagram that is partially simplified at function block B(1), B(2), and B(3), and partially detailed at function blocks B(4) and B(5).

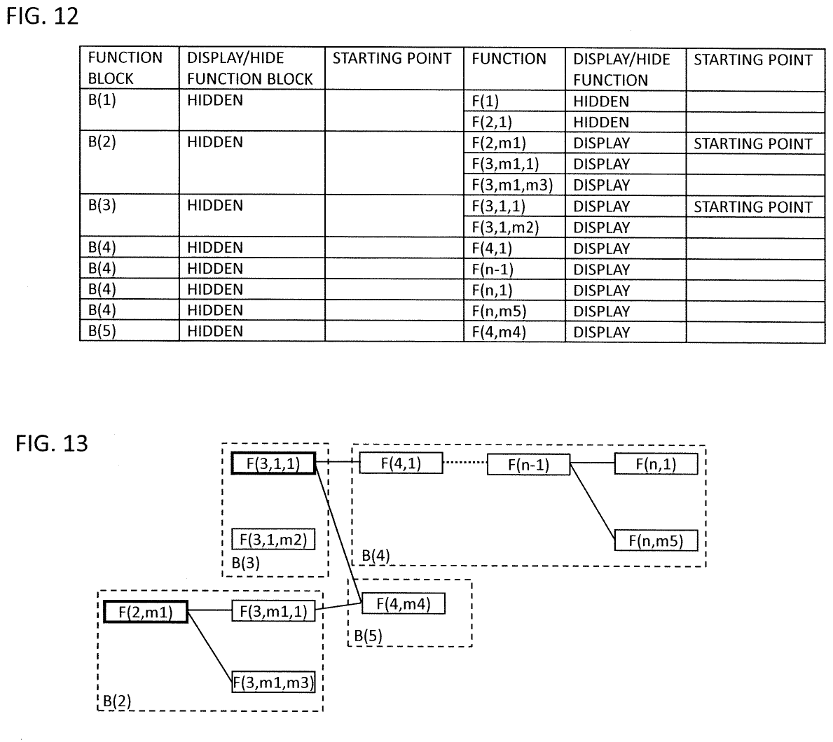

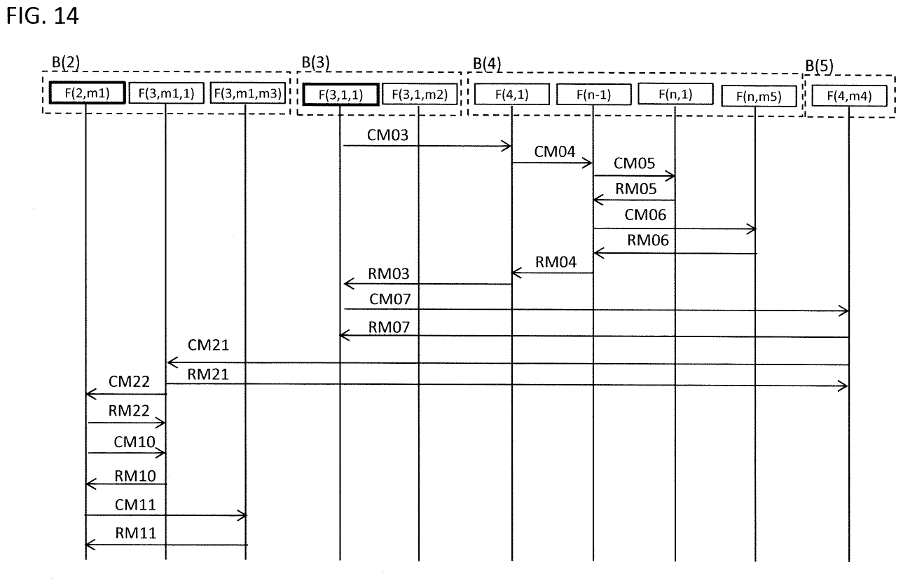

FIG. 12 is a table indicating a fourth example of generation parameters used by the sequence diagram generation apparatus 100 according to the embodiment. FIG. 13 is a fourth exemplary tree diagram corresponding to the generation parameters of FIG. 12. FIG. 14 is a fourth exemplary sequence diagram corresponding to the generation parameters of FIG. 12. In the example of FIG. 12, the generation parameters are set so as to generate a tree diagram not including functions F(1), F(2,1) and function block B(1). In the example of FIG. 13, a tree diagram including functions F(2,m1) and F(3,1,1) as starting points where the processing starts is generated. In addition, in the example of FIG. 13, function F(4,m4) is called from function F(3,m1,1). In the example of FIG. 14, a call message CM21 and a return message RM21 are issued between functions F(3,m1,1) and F(4,m4), and a call message CM22 and a return message RM22 are issued between function F(3,m1,1) and F(2,m1).

According to the sequence diagram generation apparatus 100 of the embodiment, it is possible not only to specify and change the granularity of the sequence diagram as illustrated in FIGS. 3 to 7, but also to specify and change the starting point and the scope of the sequence diagram as illustrated in FIGS. 8 to 14. Therefore, in the sequence diagram or the tree diagram, it is possible to change the granularity of any software component at any time.

The generation parameters may include not only functions and function blocks, but also include software components of other granularities (for example, processes, modules, packages, classes, etc.). The plurality of software components includes a plurality of first software components of a smaller granularity, and at least one second software component of a larger granularity, including at least one first software component. The tree diagram generator 8 may generate a tree diagram including the first software component, the second software component, or a combination of the first and second software components. The sequence diagram generator 10 may generate a sequence diagram including the first software component, the second software component, or the combination of the first and second software components.

In addition, the source code analyzer 3 may extract not only a function, but also software components of other granularities, from the source code.

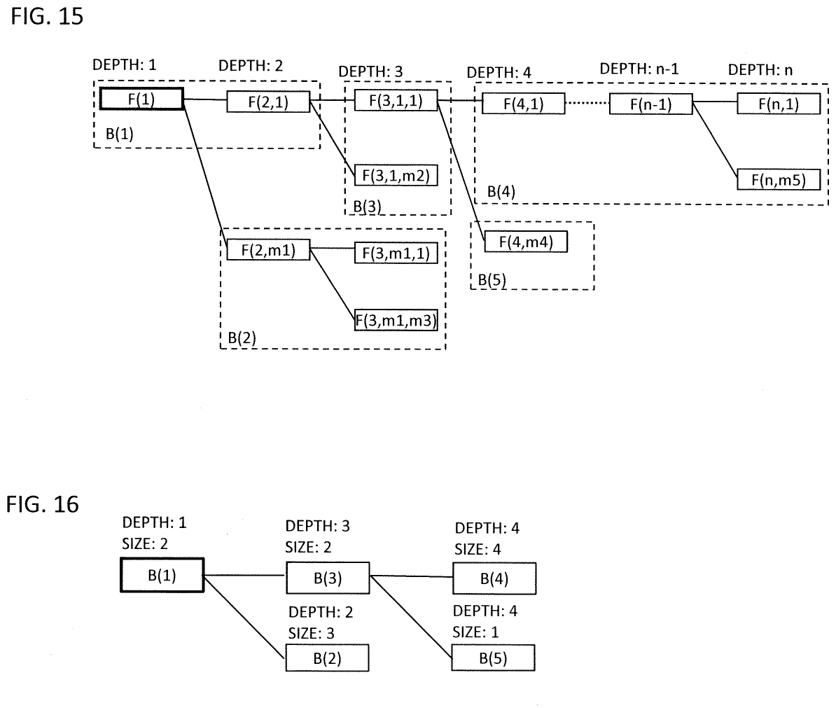

In addition, when displaying the generated tree diagram on the display device 12, the tree diagram generator 8 may display additional information in association with the software components included in the tree diagram, as will be described with reference to FIGS. 15 to 18.

FIG. 15 is a fifth exemplary tree diagram displayed by the sequence diagram generation apparatus 100 according to the embodiment. The tree diagram generator 8 may display, on the display device 12, the depth of calls of each software component included in the tree diagram, in association with the corresponding software component. In the example of FIG. 15, the tree diagram generator 8 sets function F(1) as the starting point where the processing starts, and displays the depth of calls of each function in association with the corresponding function, on the display device 12.

FIG. 16 is a sixth exemplary tree diagram displayed by the sequence diagram generation apparatus 100 according to the embodiment. In a case where the software components include a plurality of subcomponents, the tree diagram generator 8 may display, on the display device 12, the number of subcomponents included in each software component included in the tree diagram (that is, a sizes of each software component), in association with the corresponding software component. In the example of FIG. 16, the tree diagram generator 8 sets the function block B(1) as the starting point where the processing starts, and displays, on the display device 12, the depth of calls of each function block, and the number of functions included in each function block, in association with the corresponding function block.

According to the examples of FIGS. 15 and 16, it is possible to easily check the position and the size of each software component in the source code, by displaying the depth of calls of each software component, and displaying the number of subcomponents included in each software component. Thus, it is possible to easily specify and change the starting point, scope, and granularity of the sequence diagram. Therefore, it is possible to make the source code analysis efficient, and improve the quality of the source code.

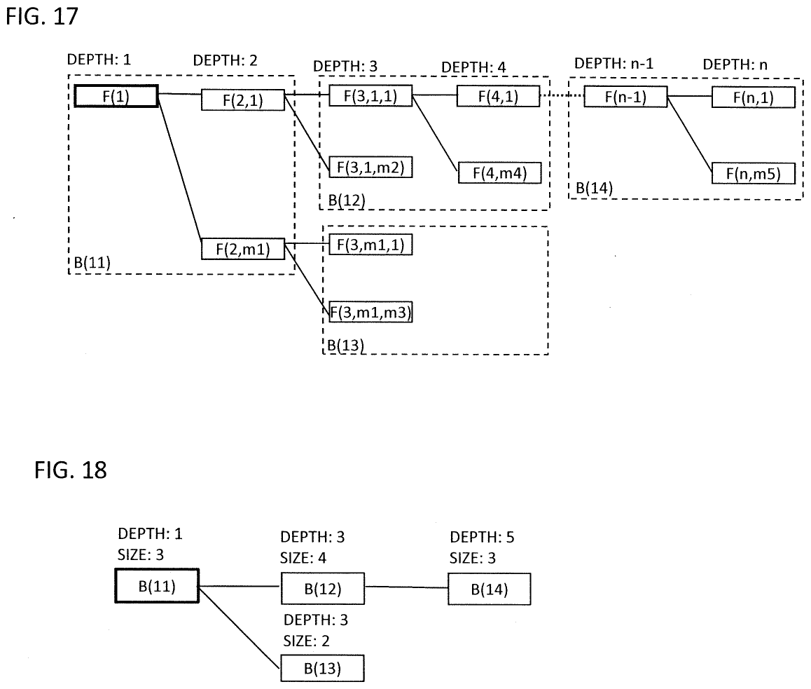

FIG. 17 is a seventh exemplary tree diagram displayed by the sequence diagram generation apparatus 100 according to the embodiment. The control device 6 may automatically group the plurality of software components extracted from the source code by the source code analyzer 3. In the example of FIG. 17, in a case where the depth of calls of functions for the entire tree diagram is “6”, the functions are grouped into function blocks such that the depth of calls of function blocks for the entire tree diagram is “3”, in other words, the depth of calls of functions for each function block is “2”. In addition, in the example of FIG. 17, a plurality of called functions that are called from a common calling function are included in the same function block. For example, function block B(11) includes functions F(1), F(2,1), and F(2,m1).

FIG. 18 is an eighth exemplary tree diagram displayed by the sequence diagram generation apparatus 100 according to the embodiment. The sequence diagram generation apparatus 100 is not limited to initially generate a tree diagram of the entire source code including all the functions of the source code, but may be configured to generate a tree diagram including some software components of the source code. The tree diagram generator 8 may determine software components included in a tree diagram, and software components excluded from the tree diagram, based on a predetermined parameter indicating the depths of calls of software components in the entire tree diagram. In the example of FIG. 18, the tree diagram generator 8 generates a tree diagram including function blocks B(11) to B(14), and not including functions, so that the depth of calls of software components for the entire tree diagram is “3”.

Thus, when the depth of calls of the software components for the entire source code is larger than a predetermined threshold, a plurality of software components may be grouped, and the entire source code may be displayed as several groups having the depths of calls smaller than the threshold. Accordingly, even in a case of a large-scale source code including a large number of software components, it is possible to generate a tree diagram and a sequence diagram indicating the entire source code. It is possible to make the source code analysis efficient, and improve the quality of the source code.

We now consider a case of selecting and displaying only one of groups of software components obtained by grouping based on the threshold. In a case where the depth of calls of the software components included in the selected group is still larger than the threshold, the software components included in this group may be regrouped into several groups and displayed. For example, in a case where the depth of calls of software components for the entire source code is “30”, and the threshold is “3”, at first, the software components of the source code are grouped into three groups each having the depth “10”. Next, in a case of selecting and displaying one of the three groups, the software components of the selected group are regrouped into three groups having the depths of, for example, “3”+“3”+“4”. Further, in a case of selecting and displaying one of the three groups, the software components of the selected group are regrouped into three groups having the depths of, for example, “1”+“1”+“2” or “1”+“1”+“1”.

### Other Modified Embodiment

Although the starting points are highlighted in the illustrated tree diagrams and sequence diagrams, other software components in the tree diagram and the sequence diagram may be highlighted to be distinguishable. For example, a specific character string may be preset as a conditional expression, a function or a function block having a function name or function block name including the character string may be extracted using a typical character string search feature, and the function or the function block may be highlighted to be distinguishable. The tree diagram generator 8 generates a tree diagram such that a part of the plurality of software components is highlighted to be distinguishable from other software components. The tree diagram generator 8 may highlight certain software components using indication of, for example, marks, colors, border modifications (thick lines, etc.), depths of calls, orders, and the like. By highlighting certain software components in the tree diagram to be distinguishable, it is possible to narrow down the scope of the sequence diagram, while specifying the software components and checking the scope, regardless of the sizes of the software components. In addition, in a case where a plurality of software components exists in the tree diagram, the software components are highlighted to be distinguishable, it is possible to narrow down the scope of the sequence diagram to be outputted, while specifying the software components and checking the scope. In addition, in a case where a plurality of software components exists in the tree diagram, By displaying the numbers of subcomponents, and displaying the depths and orders of calls, it is possible to easily generate a sequence diagram including all notable functions and/or function blocks completely.

In addition, the control device 6 may store supplementary information together with the generation parameters, the supplementary information being to be referred to when grouping functions into function blocks, or when determining a starting point from which processing starts. The supplementary information includes, for example, a file name, a name of a feature of a function, a feature description, an overview of processing, a variable name to be used or updated, a dependency, and the like. The control device 6 may extract the supplementary information from the source code, or may acquire the supplementary information from a user through the user input device 5.

In the embodiment, the tree diagram and the sequence diagram are generated based on the software components and the call relationship extracted by the source code analyzer 3. Alternatively, a tree diagram and a sequence diagram may be generated based on software components and a call relationship extracted from a result of analyzing an operation log outputted when executing a computer program.

In addition, in a case where software components (functions and/or function blocks) to be included in the sequence diagram are known in advance, the starting point, scope, and granularity of the sequence diagram can be specified by directly inputting the software components through the user input device 5.

### INDUSTRIAL APPLICABILITY

The sequence diagram generation apparatus according to one aspect of the present invention is useful for making the source code analysis efficient and improving the quality of the source code.

### REFERENCE SIGNS LIST

1: STORAGE DEVICE (SOURCE CODE)
2: DATA INPUT DEVICE
3: SOURCE CODE ANALYZER
4: STORAGE DEVICE (SOFTWARE COMPONENTS AND CALL RELATIONSHIP)
5: USER INPUT DEVICE
6: CONTROL DEVICE
7: STORAGE DEVICE (GENERATION PARAMETER)
8: TREE DIAGRAM GENERATOR
9 STORAGE DEVICE (TREE DIAGRAM)
10: SEQUENCE DIAGRAM GENERATOR
11: STORAGE DEVICE (SEQUENCE DIAGRAM)
12: DISPLAY DEVICE
13: DATA OUTPUT DEVICE
14: STORAGE DEVICE (SEQUENCE DIAGRAM)
100: SEQUENCE DIAGRAM GENERATION APPARATUS

1. A sequence diagram generation apparatus for generating a sequence diagram from a source code including a plurality of software components, the apparatus comprising:
a source code analyzer configured to extract the software components from the source code, and extract a call relationship indicating a relationship on calls and returns among the software components;
a tree diagram generator configured to generate a tree diagram of the source code based on the software components and the call relationship extracted by the source code analyzer; and
a sequence diagram generator configured to generate a sequence diagram of the source code based on the software components and the call relationship extracted by the source code analyzer,
wherein the tree diagram generator generates a tree diagram including specified software components, and excluding other specified software components, and
wherein the sequence diagram generator generates a sequence diagram including the software component included in the tree diagram generated by the tree diagram generator, and excluding the software component excluded from the tree diagram generated by the tree diagram generator.

2. The sequence diagram generation apparatus as claimed in claim 1, further comprising:
a display device configured to display the tree diagram and the sequence diagram; and
a user input device configured to acquire user inputs individually specifying the software components to be included in the tree diagram, and the software components to be excluded from the tree diagram.

3. The sequence diagram generation apparatus as claimed in claim 2,
wherein the software components include a plurality of first software components, and at least one second software component including at least one of the first software components,
wherein the tree diagram generator generates the tree diagram including the first software component, the second software component, or a combination of the first and second software components, and
wherein the sequence diagram generator generates the sequence diagram including the first software component, the second software component, or the combination of the first and second software components.

4. The sequence diagram generation apparatus as claimed in claim 3,
wherein the tree diagram generator displays, on the display device, a number of the first software components included in each of the second software components included in the tree diagram, in association with the corresponding second software component.

5. The sequence diagram generation apparatus as claimed in claim 2,
wherein the tree diagram generator displays, on the display device, depths of the calls of the software components included in the tree diagram, in association with the corresponding software components.

6. The sequence diagram generation apparatus as claimed in claim 2,
wherein the tree diagram generator generates the tree diagram such that a part of the software components is highlighted to be distinguishable from other part of the software components.

7. The sequence diagram generation apparatus as claimed in claim 1,
wherein the tree diagram generator determines the software components to be included in the tree diagram, and the software components to be excluded from the tree diagram, based on a predetermined parameter indicating depths of the calls of the software components in the entire tree diagram.

8. A sequence diagram generation apparatus for generating a sequence diagram from a source code including a plurality of software components, the apparatus comprising:
a source code analyzer configured to extract the software components from the source code, and extract a call relationship among the software components;
a tree diagram generator configured to generate a tree diagram of the source code based on the software components and the call relationship extracted by the source code analyzer; and
a sequence diagram generator configured to generate a sequence diagram of the source code based on the software components and the call relationship extracted by the source code analyzer,
wherein the tree diagram generator generates the tree diagram with a starting point, a scope and a granularity being determined by specifying software components to be included in the tree diagram, and software components to be excluded from the tree diagram, and
wherein the sequence diagram generator generates the sequence diagram based on the starting point, the scope and the granularity of the tree diagram generated by the tree diagram generator.
